(19) United States
(12) Patent Application Publication
(10) Pub. No.: US 2025/0324919 A1
(43) Pub. Date: Oct. 23, 2025

(54) COMBINATION PLANTER AND GASEOUS SOIL ADDITIVE APPLICATOR

(71) Applicant: Matt Goodman, Rhodes, IA (US)

(72) Inventor: Matt Goodman, Rhodes, IA (US)

(21) Appl. No.: 19/182,314

(22) Filed: Apr. 17, 2025

Related U.S. Application Data
(60) Provisional application No. 63/635,316, filed on Apr. 17, 2024.

(51) Int. Cl. A01C 7/06; A01C 7/08; A01C 23/02

(52) U.S. Cl. CPC A01C 7/06; A01C 7/082; A01C 23/024

(57) ABSTRACT

A combination seed planter and gaseous soil additive applicator is disclosed. The planter includes seeding modules and gas additive applying modules that are offset laterally from each other. A standard planter may be modified by replacing seed tubes with gas tubes in alternating units.

### CROSS REFERENCE TO RELATED APPLICATION

This application claims priority pursuant to 35 U.S.C. § 119 from U.S. Provisional Application Ser. No. 63/635,316 filed Apr. 17, 2024, the entire contents of which are hereby incorporated by reference.

### TECHNICAL FIELD

The invention relates generally agricultural implements and more particularly to implements for applying gaseous soil additives to agricultural fields.

### BACKGROUND

Anhydrous ammonia is an important additive to increase nitrogen levels in agricultural soils. It is most common to apply anhydrous ammonia in the fall after harvest, though it is also known to apply in the spring before planting. The primary advantage of spring application is that it avoids leaching or other losses of nitrogen from the soil before the nitrogen is used by the intended crops. However, spring application has certain disadvantages, namely the risk of not having favorable conditions to apply before planting and risk of damaging seeds by over-exposure to the fresh ammonia.

It would be beneficial if ammonia could be applied simultaneously with planting because it would reduce loss of nitrogen and avoid the risk of not having enough time with favorable weather conditions before planting time.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide an apparatus that permits the application of anhydrous ammonia or other gaseous soil additives at the same time as planting.

According to one embodiment disclosed an agricultural implement includes a frame; a first hitch at a front portion of the frame for connection to a towing vehicle; a second hitch at a rear portion of the frame for connection to a trailer; a pressure vessel supported by the trailer, the pressure vessel including a supply of liquid anhydrous ammonia; an evaporator valve in operable connection to the pressure vessel; a plurality of gas applying modules, wherein each gas applying module includes an additive soil opener and an additive soil closer; wherein each gas applying module is offset laterally from an adjacent gas applying module by a uniform row space. Optionally the implement also includes a plurality of planting modules wherein each planting module comprises a soil opener and a soil closer and wherein each planting module is offset laterally from an adjacent planting module by the uniform row space; wherein each gas applying module is offset laterally from adjacent planting modules by half the uniform row space, and further wherein a plurality of gas conduits are in fluid connection with the evaporator valve, each of the gas conduits comprising corresponding tail portions; and wherein each of the tail portions terminates between the additive soil opener and the additive soil closer of the corresponding gas applying module. The gas applying modules may be offset forwardly or rearwardly from the planting modules. The gas conduits may be insulated by an insulating layer. The insulating layer may be a reflective bubble insulation wrap.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a top plan view of a combination agricultural planter and gaseous soil additive applicator being pulled by a tractor.

FIG. 2 is a perspective view of the agricultural planter of FIG. 1 from the perspective of the tractor.

FIG. 3 is a side elevation view of a seed planting module according to one embodiment of the present disclosure.

FIG. 4 is a side elevation photograph of a gaseous additive applying module according to one embodiment of the present disclosure.

FIG. 5 is a side elevation view of a gas applying module according to another embodiment of the present disclosure.

FIG. 6 is a side view of a gas tube and a seed tube that are used in a gas applying module and a seed planting module respectively according to one embodiment of the present disclosure.

FIG. 7 is a side elevation view of a portion of a gaseous additive applying unit according to the present invention.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless specifically indicated.

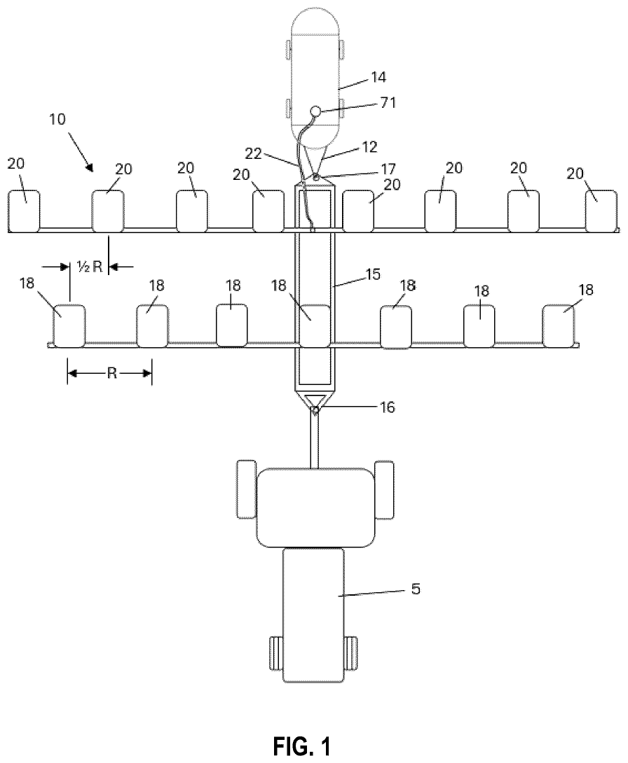

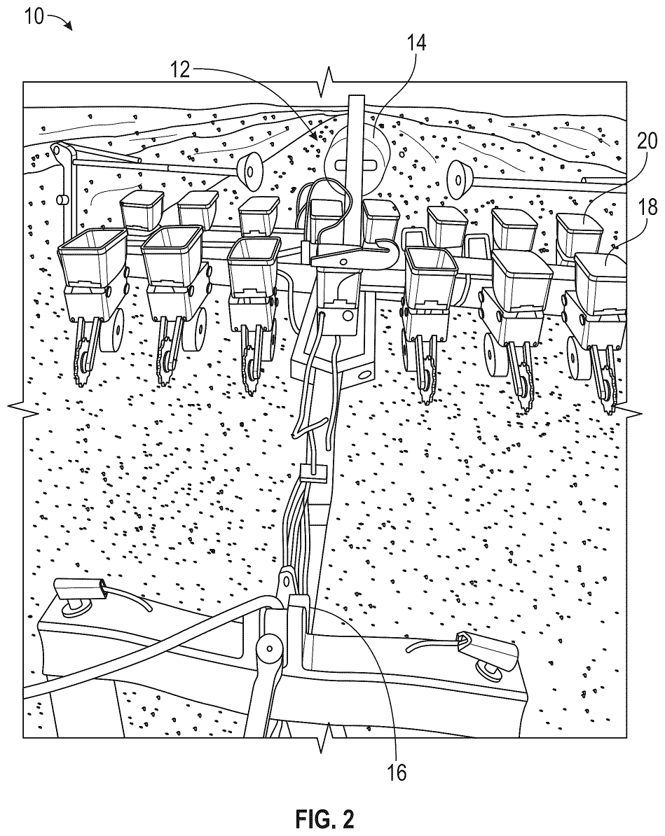

As best seen in FIGS. 1 and 2, this disclosure relates to an agricultural planter 10 that can used to simultaneously plant seeds and apply a gaseous (gas phase) soil additive, such as anhydrous ammonia. The planter 10 includes a front hitch 16 that permits the planter 10 to be connected to a towing vehicle such as a tractor 5 to move the planter 10 through an agricultural field. The planter 10 also includes a rear hitch 17 that permits a trailer 12 supporting a pressurized liquid vessel 14 to be towed behind the planter 10. The pressurized liquid vessel 14 may contain a soil additive such as liquid anhydrous ammonia.

The planter 10, according to one embodiment, is a Kinze brand planter Model 3500, that has been modified. In particular, the planter, prior to modification, was the type that included a front row of seed planting modules and a rear row of seed planting modules—wherein it is intended that one of rows of seed planting modules would be used for planting a first type of seeds, for example beans and the other of the rows of seed planting modules would be used for planting a second type of seeds, for example corn. Each of the seed planting modules is spaced laterally from an adjacent module by a space R equal to the standard space between planted rows of crops, for example about 30 inches. The rear row of seed planting modules is offset laterally from the front row of seed planting modules in the front row are centered laterally between the planting modules in rear row, when viewed from the front. As described in more detail below, in the present disclosure, the planting modules in the rear row are modified to be gaseous additive applying modules by replacing the seed tubes in the rear row of modules with gas tubes. However, it should be understood that the gaseous additive applying modules could be used in the front row of modules instead, or in any desired sequence. For example, all of the units could be gaseous additive applying modules. Alternatively, each of the modules could be provided on the same row and the modules could be alternated between seed planting modules and gas applying modules.

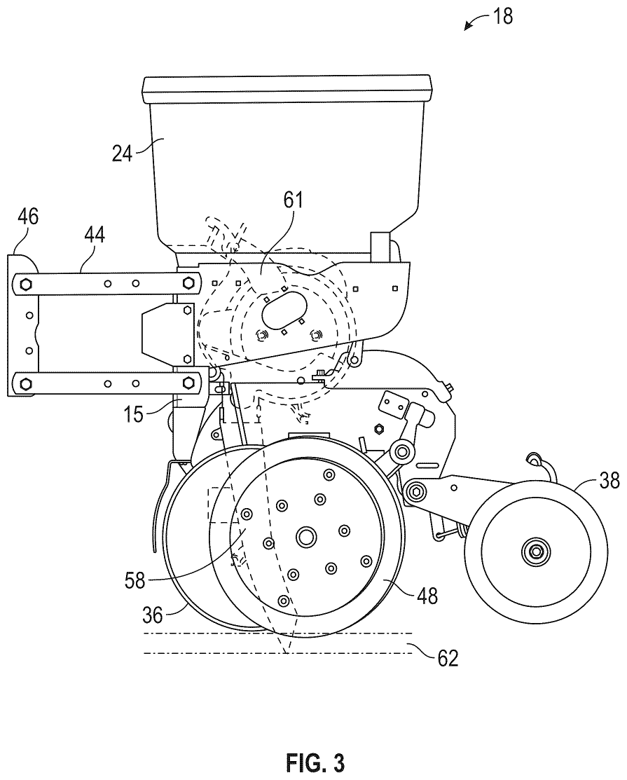

Returning to FIGS. 1 and 2, the planter 10 includes a frame 15 that supports a front row of seed planting modules 18. The seed planting modules 18 can be any standard seed planting module. The details of a seed planting modules 18 are shown in FIG. 3 and described in more detail below. In the embodiment shown, the front row includes seven (7) seed planting modules 18 that are each equally spaced from adjacent seed planting modules 18 by a uniform row space R, typically about thirty (30) inches.

As seen in FIG. 3, each seed planting module 18 includes a hopper 24 for containing a supply of agricultural seeds. A singulater 61 may be used to provide seeds one at a time to a seed tube 58 that carries the seeds into a furrow created by a soil opener such as disk 36. The seed tube 58 has an outlet that is between the soil opener 36 and the soil closing wheels 38. Guage wheels 48 are used to support the unit and control the depth of the furrow.

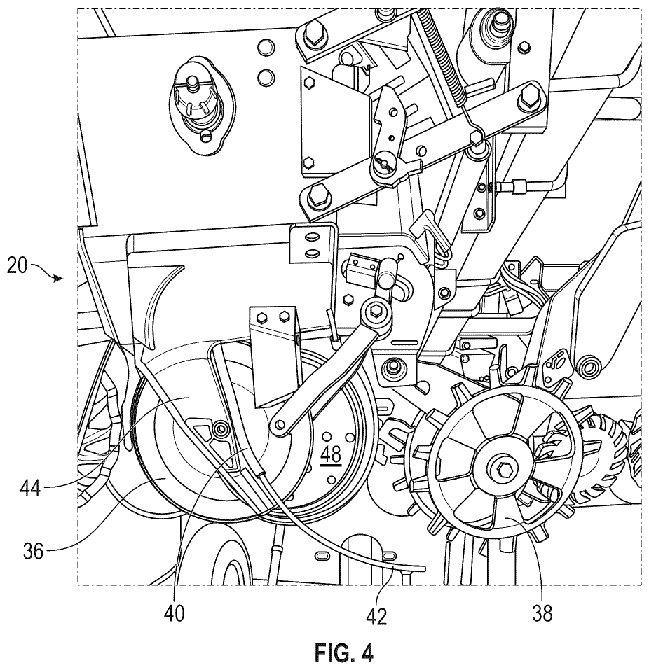

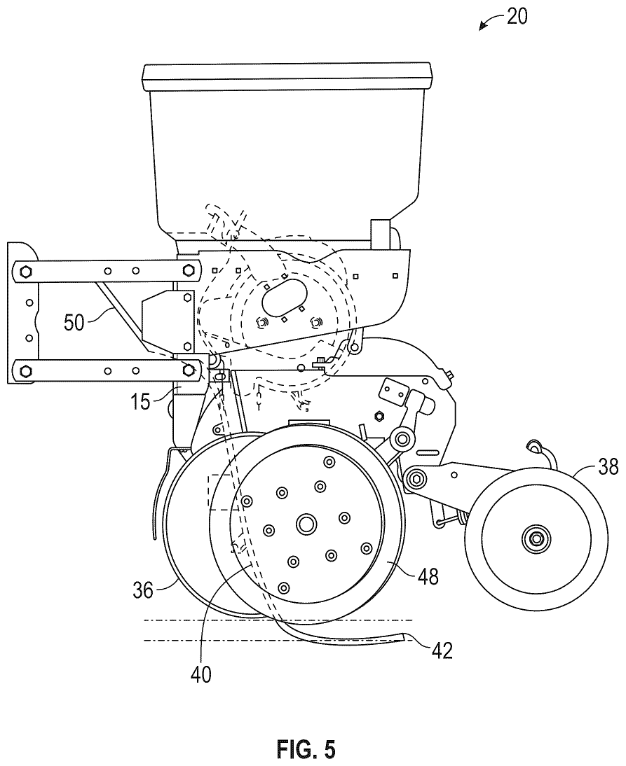

Returning again to FIGS. 1 and 2, the frame 15 also supports a rear row of gaseous additive applying modules 20. The gaseous additive modules 20 are used to apply gaseous additives, such as anhydrous ammonia to the soil. The details of a gaseous additive applying module 20 are shown in FIGS. 4 and 5 and described in more detail below. In the embodiment shown, the rear row includes eight (8) gaseous additive applying modules 20 that are each equally spaced laterally from adjacent gaseous additive applying modules by a uniform row space, typically about thirty (30) inches. The rear row of gaseous additive applying modules 20 are offset so as to be centered laterally between the front row of seed planting modules 18 when the planter 10 is pulled through a field. Accordingly, each gaseous additive applying module 20 is offset laterally from adjacent seed planning module(s) by half of a standard row spacing (1/2 R).

As seen in FIGS. 4 and 5, each gaseous additive applying module 20 includes a gas conduit 60 that receives the gas phase additive, such as anhydrous ammonia, from insulated supply line 22. The gas conduit 60 carries the gaseous additive to an insulated gas tube 40. The gas tube 40 may be a double-walled tube that has insulation, such as foam insulation, between the tubes to prevent the outside of the tube 40 from freezing and accumulating frozen condensation. Alternatively, the gas tubes 40 may be insulated by other means, such as reflective bubble wrap insulation provide on the outside of the tubes 40. An outlet tail 42 extends from the insulated gas tube 40 and extends into a furrow created by a soil opener such as disk 36. The outlet of the outlet tail 42 is provided between the soil opener 36 and a soil closer, such as soil closing wheels 38. The outlet tail 42 is intended to be a wear part that may require periodic replacement as it gets worn by interaction with the soil. According to one embodiment the outlet tail 42 is ⅜ inch diameter PEX tubing with a schedule 40⅛ inch brake line. In any event the insulated gas tube 40 and outlet tail 42 should be formed from materials that are resistant to corrosion from ammonia vapor. As best seen in FIG. 4, the insulated gas tube 40 is secured to a planter row shank 44 that acts as a mounting bracket. In a preferred embodiment, the gas additive applying modules 20 are identical to the seed planting modules 18, except the seed tube 58 of the seed planting modules are removed and replaced with the insulated gas tube 40 which is connected at its upper end to a gas conduit 60 and at its lower end to an outlet tail 42.

It should be appreciated that FIG. 5 shows the gas additive applying module 20 as a pull unit, that is being pulled by the frame 15, but in practice it could be installed as a push unit.

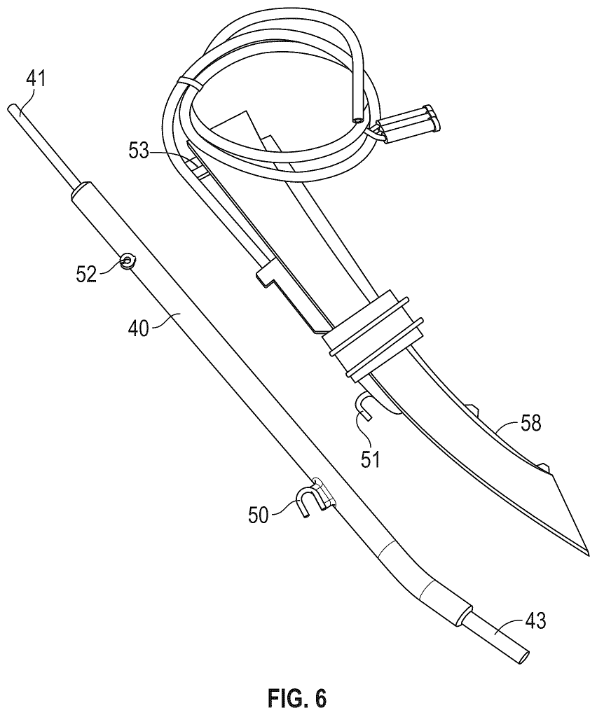

Additional details of the insulated gas tube 40 can be seen in FIG. 6. The upper end of the gas tube 40 includes a gas conduit connector stub 41 that used to connect the tube 40 to the gas conduit 60 that carries anhydrous ammonia vapor (or other gaseous soil additive) from the pressure vessel 14 to the gas tube 40. Furthermore, the gas tube 40 includes mounting hardware that matches the mounting hardware of a standard seed tube 58, so that the gas tube 40 can be mounted in place of a seed tube 58. Specifically, as shown in FIG. 6, the gas tube 40 includes a mounting hook 50 and mounting loop 52 that are spaced apart from each other the same distance as a mounting hook 51 and mounting loop 53 provided on a seed tube 58. The lower outlet end of the gas tube 40 includes an outlet portion 43 that extends beyond the insulated portion and is adapted to mate with he outlet tail 42.

The planter 20 can be used to plant seeds and apply a gaseous soil additive such as anhydrous ammonia at the same time with a single pass through the field. A pressure vessel 14 containing liquid phase additive is hitched to the rear of the planter 10 on trailer 12. The gas conduits 60 are connected to the pressure vessel 14 via gas supply line 22 and evaporator valve 71 (see FIG. 1) that controls the pressure of the gas provided to the gas conduits. Seed is loaded into the seed hoppers of the seed planting modules 18. The planter 10 is hitched to a tractor that can then pull the planter 10 through a field. Controls for the gas regulator and planting units are provided to the tractor cabin in a known manner.

As the planter 10 is pulled through the field, the seeds are planted in a conventional manner by the seed planting modules 18 with the seeds being provided into furrows created by the seed opening disks 38 via seed tubes 58 and the seeds then being covered with soil by closing wheels 38. Simultaneously, the gaseous additive is supplied to the soil by the gas additive applying modules 20. The gas additive travels from the pressure vessel 14 to the gas tubes 40 via conduits 60. The gas additive is applied into furrows created by the soil opening disks 36 and is then covered by soil by the closing wheels 38.

Because the gas furrows are offset laterally from the seed furrows by half the width (1/2 R) of the uniform planting row spacing, and the gas furrows are quickly covered with soil as the additive is applied, the fresh concentrated ammonia never contacts the seeds and is able to enrich the nitrogen content of the soil in a safe manner that does not damage the seeds. Efficiency is gained because the ammonia can be applied in a single pass through the field rather requiring separate passes for the seed and the gaseous additive. Furthermore, because it is being applied currently with the seeding, there is no loss of potency that can occur when applying in the fall, so less additive can be used.

Alternatively, the planter 10 can be operated using just the gaseous additive applying modules 20 to apply the gaseous additive at a time other than during planting, for example during the fall season after harvest.

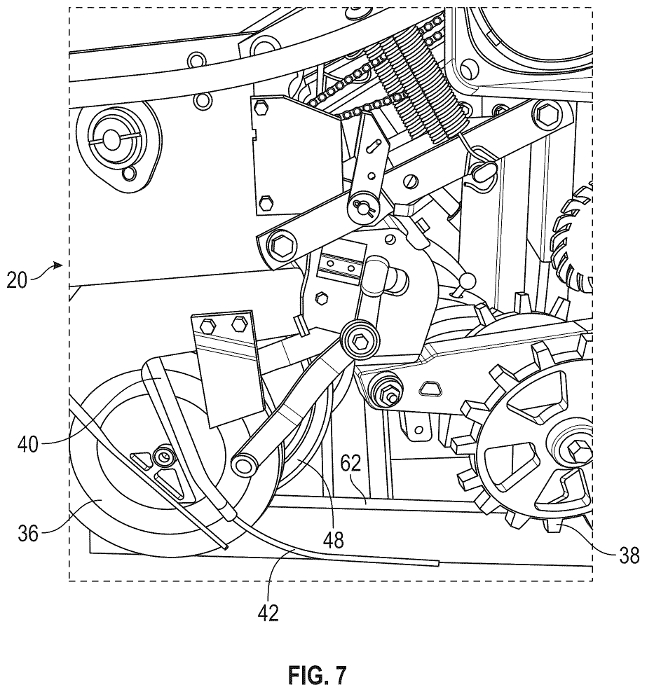

FIG. 7 shows a gaseous additive applying module 20 with a wooden 4×4 used to illustrate a soil level. As can be seen, the depth control wheel 48 rides on top of the soil and the outlet of the outlet tail 42 is below the soil level 62. The depth of the outlet tail 42, which rides on the bottom of the trench formed by the soil opener 36 can be adjusted by adjusting the depth control wheel 48. The soil closer 38 is located in close proximity to the outlet of the outlet tail 42 to quickly cover the additive and retain it in the soil as it is applied. A pressure gauge (not shown) may be connected to the gas line 22 or to one or more of the gas conduits 60 to permit monitoring of the gas pressure at each module 20.

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A combination seed planter and gaseous soil additive applicator comprising:
a frame;
a first hitch at a front portion of the frame for connection to a towing vehicle;
a second hitch at a rear portion of the frame for connection to a trailer;
a pressure vessel supported by the trailer, the pressure vessel including a supply of liquid soil additive;
an evaporator valve in operable connection to the pressure vessel;
a plurality of planting modules wherein each planting module comprises a soil opener and a soil closer and wherein each planting module is offset laterally from an adjacent planting module by a uniform row space;
a plurality of gaseous soil additive applying modules, wherein each gaseous soil additive applying module includes an additive soil opener and an additive soil closer;
wherein each gaseous soil additive applying module is offset laterally from an adjacent gaseous soil additive applying module by the uniform row space, and further wherein each gaseous soil additive applying module is offset laterally from adjacent planting modules by half the uniform row space, and
further wherein each gaseous additive applying module has a gas conduit in fluid connection with the evaporator valve, each of the gas conduits supplying gas vapor to a gas tube comprising a tail portion; and wherein each of the tail portions has an outlet between the additive soil opener and the additive soil closer of its gaseous soil additive applying module.

2. The combination seed planter and gaseous soil additive applicator of claim 1, wherein the liquid soil additive is anhydrous ammonia.

3. A gas tube for applying a gaseous soil additive, wherein the gas tube is adapted to replace a standardized seed tube of an agricultural seed planter system of the type that includes a seed tube mounting hook and a seed tube mounting loop spaced apart from each other on the seed tube by a mounting distance, the gas tube comprising:
a hollow inner tube having an upper inlet end that includes a gas conduit connector stub adapted to connect the hollow inner tube to a gas conduit that carries a gaseous soil additive;
insulation surrounding at least a portion of the hollow inner tube;
the hollow inner tube further having a lower outlet end including an outlet portion that is not surrounded by insulation;
a tail portion in mating engagement with the outlet portion, the tail portion including an opening to apply the gaseous soil additive to soil;
a gas tube mounting loop in a fixed relation to the hollow inner tube; and
a gas tube mounting hook in a fixed relation to the hollow inner tube, the gas tube mounting hook being spaced apart from the gas tube mounting loop by the mounting distance.

4. The gas tube of claim 3, wherein the insulation comprises an outer tube and foam between the outer tube and the inner tube.

5. The gas tube of claim 3, wherein the insulation comprises reflective bubble wrap.

6. A combination seed planter and gaseous soil additive applicator comprising:
a plurality of planting modules wherein each planting module comprises a soil opener and a soil closer and wherein each planting module is offset laterally from an adjacent planting module by a uniform row space;
a plurality of gaseous soil additive applying modules, wherein each gaseous soil additive applying module includes an additive soil opener and an additive soil closer;
wherein each gaseous soil additive applying module is offset laterally from an adjacent gaseous soil additive applying module by the uniform row space, and further wherein each gaseous soil additive applying module is offset laterally from adjacent planting modules by half the uniform row space, and
further wherein each gaseous additive applying module has a gas conduit adapted for connection with a supply of gas vapor and a tail portion; and wherein each of the tail portions has an outlet between the additive soil opener and the additive soil closer for applying the gas vapor to the soil.

7. The combination seed planter and gaseous soil additive applicator of claim 6, wherein:
each of the planting modules comprises a seed tube that includes seed tube mounting hardware spaced apart on the seed tube by a mounting distance; and
each of the gaseous soil additive modules comprises a gas tube that has gas tube mounting hardware spaced part on the gas tube by the mounting distance.

8. The combination seed planter and gaseous soil additive applicator of claim 7, wherein the seed tube mounting hardware on each seed tube comprises a seed tube hook and a seed tube loop and the gaseous seed tube mounting hardware comprises a gas tube hook and a gas tube loop.
